(19) United States
(12) Patent Application Publication
(10) Pub. No.: US 2024/0256956 A1
(43) Pub. Date: Aug. 1, 2024

(54) ARTIFICIAL INTELLIGENCE-BASED APPLICATION CREATION INTERFACE CONTROL METHOD AND SYSTEM

(71) Applicant: AI-NOMIS, Seoul (KR)

(72) Inventor: Si Won KIM, Uijeongbu-si (KR)

(21) Appl. No.: 18/172,144

(22) Filed: Feb. 21, 2023

Related U.S. Application Data
(63) Continuation of application No. PCT/KR2023/001401, filed on Jan. 31, 2023.

(30) Foreign Application Priority Data
Jan. 27, 2023 (KR) 10-2023-0010755

(51) Int. Cl. G06N 20/00

(52) U.S. Cl. CPC G06N 20/00

(57) ABSTRACT

An artificial intelligence-based application creation interface providing method includes: transmitting a first interface including a customizing information input portion applied to an artificial intelligence-based application to be created to the terminal, receiving customizing information set by the terminal from the terminal through the first interface, uploading learning data and pre-processing information required to generate an artificial intelligent model applied to the application when artificial intelligence model information is missing from the customizing information, transmitting a second interface including a function unit for pre-processing the learning data to the terminal, receiving the learning data and the pre-processing information required to generate the artificial intelligence model from the terminal through the second interface, generating a training dataset by pre-processing the learning data according to the pre-processing information, and providing a third interface including a download portion of the artificial intelligence model applied to the application to the terminal to output a certain result for a preset input based on the training dataset by using a system.

### BACKGROUND

### 1. Field

The present disclosure relates to an artificial intelligence-based application creation interface control method and system, and more particularly, to a method and a system that provide an app creation-related interface such that a user may easily create an artificial intelligence-based app without a separate coding process and to create an artificial intelligence-based app based on information obtained through an interface.

### 2. Description of the Related Art

Recently, artificial intelligence technology has been developed rapidly, and services using artificial intelligence are being used in various fields.

In particular, with the explosive increase in learnable data, improved hardware performance represented by a graphics processing unit (GPU), and research on various algorithms, the development of deep learning is remarkable, and services are being developed and used in various fields by utilizing computer vision, natural language processing, and reinforcement learning.

The development process of the deep learning services consists of problem definition, data collection and processing, model selection and learning, and application creation using learning results.

Among those, the field of data collection and processing has been continuously developed from the beginning due to the need for data that always corresponds to the correct answer due to the nature of deep learning. Recently, many studies have been conducted to reduce the resources required for data processing by utilizing deep learning in the field of data collection and processing itself.

In the field of model selection and learning, related models are explosively increasing due to the development of various algorithms as well as the development of deep learning frameworks of leading global companies represented by Tensor Flow and PyTorch, and the field of model selection and learning is one of the most developing fields.

On the other hand, given that the final goal of deep learning is to apply a trained model to real service, relatively little research and investment is being done in the process of building a deep learning model into an actual serviceable application.

Recently, many efforts have been made to manage the overall life cycle of deep learning using MLOps, recognizing that the time required for other tasks is greater than the proportion of model learning in deep learning, but since the developer is manually proceeding from the trained model to the application development, a lot of development resources are still being consumed.

However, it is difficult to secure developers due to the wage increase of software developers, and the secured developers are experiencing difficulties in developing and constructing information systems due to a lack of technical capabilities.

Accordingly, it is necessary to improve the quality of information systems and the shortage of developers through coding automation tools that may easily code software development even for non-developers.

### SUMMARY

In order to solve the above-described problems of the related art, the present disclosure provides a method and a system that provide an interface related to app creation such that a user may easily create an artificial intelligence-based application without a separate coding process, and generate the artificial intelligence-based application based on information acquired through the interface.

Technical objects problems to be achieved by the present disclosure are not limited to the above technical objects, and other technical objects of the present disclosure may be derived from the following description.

An embodiment according to an aspect of the present disclosure provides an artificial intelligence-based application creation interface providing method. The method includes transmitting, by the system, a first interface including a customizing information input portion applied to an artificial intelligence-based application to be created to the terminal and receiving customizing information set by the terminal from the terminal through the first interface, uploading learning data and pre-processing information required to generate an artificial intelligent model applied to the application when artificial intelligence model information applied to the application is missing from the customizing information, transmitting a second interface including a function unit for pre-processing the learning data to the terminal, receiving the learning data and the pre-processing information required to generate the artificial intelligence model applied to the application from the terminal through the second interface, and generating a training dataset by pre-processing the learning data according to the pre-processing information by using the system, and providing, by the system, a third interface including a download portion of the artificial intelligence model applied to the application to the terminal to output a certain result for a preset input based on the training dataset.

An embodiment according to another aspect of the present disclosure provides an artificial intelligence-based application creation interface providing system. The system includes a communication module, at least one processor, and a memory electrically connected to the processor and configured to store at least one code executed by the processor, wherein, when the memory is operated by the processor, the processor transmits a first interface including a customizing information input portion applied to an artificial intelligence-based application to be created to a terminal communicatively connected to the communication module, receives customizing information set by the terminal from the terminal through the first interface, loads learning data and pre-processing information required to generate an artificial intelligent model applied to the application when artificial intelligence model information applied to the application is missing from the customizing information, transmits a second interface including a function unit for pre-processing the learning data to the terminal, receives the learning data and the pre-processing information required to generate the artificial intelligence model applied to the application from the terminal through the second interface, and generates a training dataset by pre-processing the learning data according to the pre-processing information, and provides a third interface including a download portion of the artificial intelligence model applied to the application to the terminal to output a certain result for a preset input based on the training dataset.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a configuration of an application creation interface providing system according to an embodiment of the present disclosure;

FIG. 2 is a diagram illustrating a detailed configuration of an application creation interface providing system illustrated in FIG. 1;

FIGS. 3 to 8 are views illustrating examples of a first interface displayed on a terminal through an application creation interface providing system, according to an embodiment of the present disclosure;

FIGS. 9 to 15B are views illustrating examples of a second interface displayed on a terminal through an application creation interface providing system, according to an embodiment of the present disclosure;

FIGS. 16 to 21B are views illustrating examples of a third interface displayed on a terminal through an application creation interface providing system, according to an embodiment of the present disclosure;

FIG. 22 is a flowchart illustrating processes of an application creation interface providing method according to another embodiment of the present disclosure; and

FIGS. 23 to 25 are flowcharts illustrating additional processes of the application creation interface providing method illustrated in FIG. 22.

### DETAILED DESCRIPTION

Hereinafter, the present disclosure will be described in detail with reference to the accompanying drawings. However, the present disclosure may be implemented in many different forms and is not limited to the embodiments described herein. In addition, the accompanying drawings are only for easy understanding of the embodiments disclosed in the present specification, and the technical ideas disclosed in the present specification are not limited by the accompanying drawings. All terms including technical terms and scientific terms used herein should be interpreted as meanings commonly understood by those skilled in the art to which the present disclosure belongs. The terms defined in the dictionary should be interpreted as having additional meanings corresponding to the related technical documents and the currently disclosed content and are not interpreted in a very ideal or limiting sense unless otherwise defined.

In order to clearly describe the present disclosure in the drawings, parts irrelevant to the descriptions are omitted, and a size, a shape, and a form of each component illustrated in the drawings may be variously modified. The same or similar reference numerals are assigned to the same or similar portions throughout the specification.

Suffixes “module” and “unit” for the components used in the following description are given or used interchangeably in consideration of ease of writing the specification, and do not have meanings or roles that are distinguished from each other by themselves. In addition, in describing the embodiments disclosed in the present specification, when it is determined that a detailed descriptions of related known technologies may obscure the gist of the embodiments disclosed in the present specification, the detailed descriptions are omitted.

Throughout the specification, when a portion is said to be “connected (coupled, in contact with, or combined)” with another portion, this includes not only a case where it is “directly connected (coupled, in contact with, or combined)”, but also a case where there is another member therebetween. In addition, when a portion “includes (comprises or provides)” a certain component, this does not exclude other components, and means to “include (comprise or provide)” other components unless otherwise described.

Terms indicating ordinal numbers, such as first and second, used in the present specification are used only for the purpose of distinguishing one component from another component and do not limit the order or relationship of the components. For example, the first component of the present disclosure may be referred to as the second component, and similarly, the second element may also be referred to as the first component. Singular forms used herein should be construed to include plural forms as well, unless clearly indicated to the contrary.

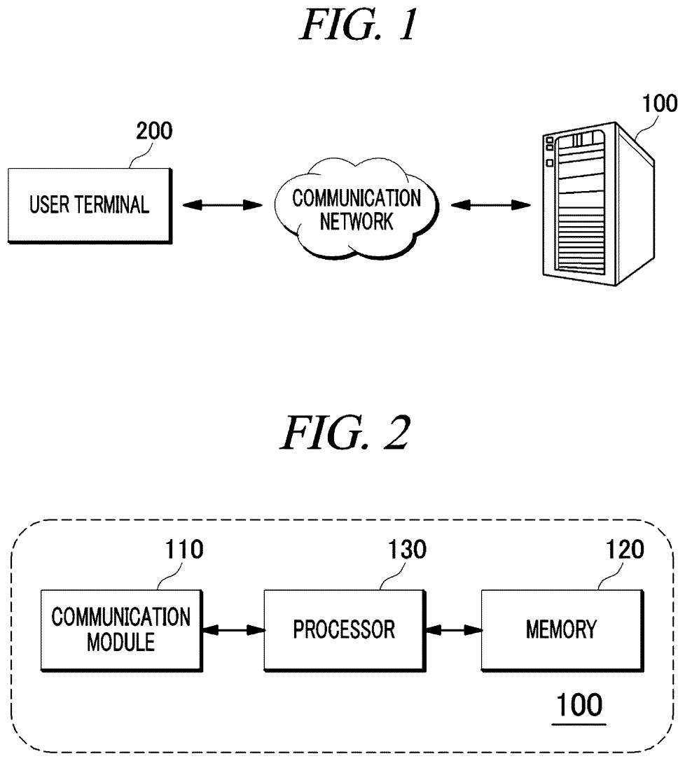

FIG. 1 is a block diagram illustrating a configuration of an application creation interface providing system according to an embodiment of the present disclosure.

Referring to FIG. 1, an application creation interface providing system includes a system 100 and a terminal 200. The system 100 and the terminal 200 may be connected to each other through a wireless communication network. Although only one terminal 200 is illustrated in FIG. 1 for the sake of convenience, the application creation interface providing system may be implemented in a form in which a plurality of terminals are connected to the system 100 through a wireless network.

The system 100 may provide first to third interfaces to the terminal 200. However, the present disclosure is not limited thereto, and a plurality of interfaces or a single interface may be provided as needed.

The system 100 provides the first interface to the terminal 200. Here, the first interface includes a customizing information input portion applied to an artificial intelligence (AI)-based application (hereinafter, referred to as an “app”) to be created.

The system 100 receives customization information set by the terminal 200 from the terminal 200 through the first interface.

The system 100 transmits the second interface to the terminal 200 when AI model information applied to the app is missing among the customization information. The second interface includes function units that upload learning data and pre-processing information required to create an AI model applied to the app and pre-process the learning data.

The system 100 receives the learning data and the pre-processing information required to generate an AI model applied to the app from the terminal 200 through the second interface.

The system 100 pre-processes the learning data according to the pre-processing information to generate a training dataset.

The system 100 provides the third interface to the terminal 200. The third interface includes a download portion of an AI model applied to the app to output a certain result of a preset input based on the training dataset. For example, when the training dataset is a heart image, the third interface may include a download portion of an AI model capable of downloading the AI model that receives the heart image and outputs presence or absence of cardiac hypertrophy.

The system 100 may operate in a cloud computing service model, such as software as a service (Saas), platform as a service (PaaS), or infrastructure as a service (IaaS). In addition, the system 100 may be implemented in the form of a private cloud, a public cloud, or a hybrid cloud.

The terminal 200 may display at least one of a plurality of interfaces received from the system 100 through a display.

The terminal 200 may transmit information corresponding to the information included in the interface to the system 100 through the interface received from the system 100.

The terminal 200 may transmit, to the system 100, at least one piece among customizing information, data, pre-processing information, training degree information, image learning data, image pre-processing information, comma separated value (CSV) learning data, CSV pre-processing information, AI model basic information, training and verification data ratio, layer information, and parameter information.

The terminal 200 may include, for example, a notebook computer, a desktop computer, and a laptop computer equipped with a web browser, a wireless communication device that ensures portability and mobility, all types of handheld-based wireless communication devices, such as a smartphone, a tablet personal computer (PC), and so on.

In addition, the communication network illustrated in FIG. 1 may be implemented by all kinds of wireless networks, for example, a wired network, such as a local area network (LAN), a wide area network (WAN), or a value added network (VAN), a mobile radio communication network, and a satellite communication network.

FIG. 2 is a diagram illustrating a detailed configuration of the application creation interface providing system illustrated in FIG. 1. Hereinafter, the system 100 will be described in detail with reference to FIGS. 1 and 2.

The system 100 includes a communication module 110, a processor 120, and a memory 130. An application creation interface providing method performed by an application creation interface providing system may be independently performed in the system 100. The system 100 may be implemented in the form of a computer or a cloud platform, but the scope of the present disclosure is not limited thereto.

The communication module 110 may transmit and receive data to and from the terminal 200. For example, the communication module 110 may transmit at least one interface to the terminal 200. The communication module 110 may receive at least one piece among customizing information, data, pre-processing information, training degree information, image learning data, image pre-processing information, CSV learning data, CSV pre-processing information, AI model basic information, training and verification data ratio, layer information, and parameter information.

The communication module 110 may include hardware and software necessary for transmitting and receiving signals, such as control signals and data signals, to and from other network devices through wired or wireless connections.

The processor 120 may include various types of devices that control and process data. The processor 120 may refer to a data processing device which is embedded in hardware and includes a physically structured circuit to perform functions represented by codes or instructions included in a program.

In one example, the processor 120 may be implemented in the form of a microprocessor, a central processing portion (CPU), a processor core, a multiprocessor, an application-specific integrated circuit (ASIC), a field programmable gate array (FPGA), or so on, but the scope of the present disclosure is not limited thereto.

The processor 120 of the system 100 performs operations according to codes stored in the memory 130.

The memory 130 of the system 100 is electrically connected to the processor 120 and stores at least one code processed by the processor 120. The memory 130 stores codes that cause the processor 120 to perform following functions and procedures when processed by the processor 120.

The memory 130 provides the first interface to the terminal 200. Here, the first interface includes a customizing information input portion applied to an AI-based application (hereinafter, referred to as an “app”) to be created. The customizing information input portion may include at least one of an app name input portion, an app description input portion, and an AI model information input portion.

The first interface may include first to fourth templates required to create an app.

The memory 130 receives customization information set by the terminal 200 from the terminal 200 through the first interface.

The memory 130 may transmit, to the terminal, a first template including the app name input portion, the app description input portion, and the AI model information input portion applied to an app.

The memory 130 may receive app name information, app description information, and AI model information through the first template. Here, the AI model information may indicate presence or absence of a trained AI model.

The memory 130 may create a basic app based on the received the app name information, the app description information, and the AI model information.

The memory 130 may transmit a second template including an app configuration information input portion necessary for creating an app to a terminal and receive app configuration information through the second template. Here, the app configuration information may include at least one of position information, size information, character color information, background color information, and alignment information of elements for implementing the app.

The memory 130 may transmit, to the terminal 200, a third template including an AI model training level input portion and a training result checking portion.

Training degree information of an AI model may be received through the third template. Here, the training result checking portion may visualize a training result value as a numerical value and a graphs and provided the visualized training result value.

The memory 130 may create an app based on a basic app, a trained AI model, and app configuration information, and provide a fourth template including an app link providing portion necessary to provide the created app. Here, the app link providing portion may include at least one of a QR code and a uniform resource locator (URL) through which a created app may be downloaded or which accesses the app.

The memory 130 transmits the second interface to the terminal 200 when AI model information applied to the app is missing among the customization information.

Here, the second interface includes a function unit that uploads learning data and pre-processing information required to generate an AI model applied to an app and pre-processes the learning data. In addition, the second interface may include fifth to tenth templates required to generate a training dataset by pre-processing the learning data.

The memory 130 receives the learning data and the pre-processing information required to generate an AI model applied to the app from the terminal 200 through the second interface.

For example, the memory 130 may transmit, to the terminal 200, a fifth template including a learning data upload portion, a data name input portion, a data description input portion, and a data type input portion required to generate a training dataset.

The memory 130 may receive learning data information, training data name information, training data description information, and learning data type information through the fifth template. Here, the learning data type information may be one of an image or a CSV.

The memory 130 pre-processes the learning data according to the pre-processing information to generate the training dataset. Here, the memory 130 may generate the training dataset by providing different templates according to the received dataset.

For example, when the type of learning data is an image dataset, the memory 130 may transmit, to the terminal 200, a sixth template including an image learning data upload portion required to upload image learning data.

The memory 130 may receive the image learning data through the sixth template. Here, the terminal 200 may select the image learning data through at least one of a ZIP folder file, download through a URL, and Internet search crawling through a scraper engine, and the memory 130 may receive the selected image learning data.

The memory 130 may transmit, to the terminal 200, a seventh template including an image pre-processing portion required to label, add, or remove the image learning data.

The memory 130 may receive image pre-processing information through the seventh template. Here, the image pre-processing information may include information for adding new image learning data or removing the existing image learning data.

When the type of learning data is CSV data of a CSV format, the memory 130 may transmit, to the terminal 200, an eighth template including a CSV learning data upload portion required to upload the CSV learning data.

The memory 130 may receive CSV learning data through the eighth template.

The memory 130 may transmit, to the terminal 200, a ninth template including a CSV information correction portion for CSV data information and a CSV learning data pre-processing portion required to pre-process the CSV learning data. Here, the CSV data information may include at least one of title modification information and column removal information of column values of the CSV file.

The memory 130 may receive CSV pre-processing information through the ninth template. Here, the CSV pre-processing information may include at least one of NULL value removal information, zero removal information, normalization information, trimming information, blank filling information, and thousand-unit comma removal information.

The memory 130 may transmit, to the terminal 200, a 10th template including a graph providing portion required to visualize and display the CSV training data generated through pre-processing. Here, the memory 130 may visualize and provide relative distribution display information obtained by matching a reference data column with data in another column and a bar graph of the selected data.

The memory 130 provides the third interface to the terminal 200. Here, the third interface includes a download portion of an AI model applied to an app to output a certain result for a preset input based on a training dataset. In addition, the third interface may include eleventh to fifteenth templates required to generate an AI model applied to an app, train the AI model, and download the AI model applied to the app.

The memory 130 may transmit, to the terminal 200, an eleventh template including an AI model name input portion for inputting basic information of the AI model, an AI model description input portion, a training data upload portion, and a training data sample selection portion.

The memory 130 may receive AI model basic information through the eleventh template.

The memory 130 may transmit, to the terminal 200, a twelfth template including a training information selection portion required to select a training and verification data ratios of training data.

The memory 130 may receive the training and verification data ratios through the twelfth template.

The memory 130 may transmit, to the terminal 200, a thirteenth template including a layer generation portion required to generate layers constituting the AI model.

The memory 130 may receive layer information through the thirteenth template. Here, the layer information may include detailed element information of each of layers and sequential arrangement information of the layers.

The memory 130 may transmit, to the terminal 200, a fourteenth template including a parameter setting portion required to set parameters necessary for model training.

The memory 130 may receive parameter information through the fourteenth template. Here, the parameter information may include input information, output information, data type information, optimizer information, loss value information, metric information, learning rate information, epoch information, batch size information, x value information, and y value information. When the learning data is an image, the learning data may further include image size information and channel information.

The memory 130 may transmit the fifteenth template to the terminal 200. Here, the fifteenth template may include an AI model training portion, a download portion, and a real-time monitoring portion. The AI model training portion may train an AI model according to the parameter information. The download portion may enable the terminal 200 to download the AI model that is trained and stored. The real-time monitoring portion may provide a training situation of the stored AI model in real time.

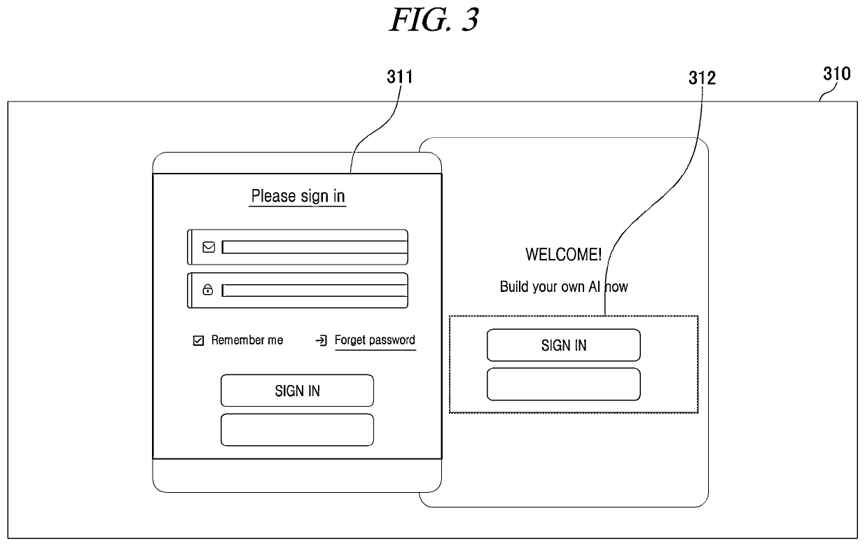

FIGS. 3 to 8 are views illustrating examples of the first interface displayed on a terminal through an application creation interface providing system according to an embodiment of the present disclosure.

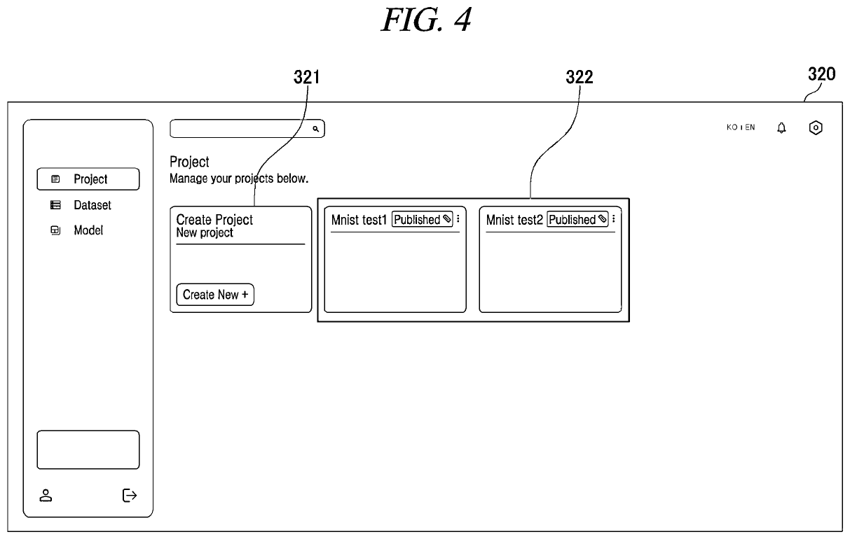

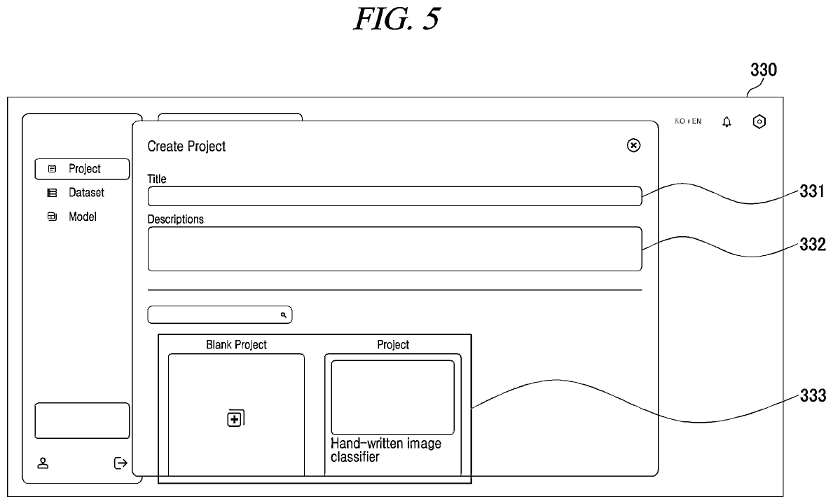

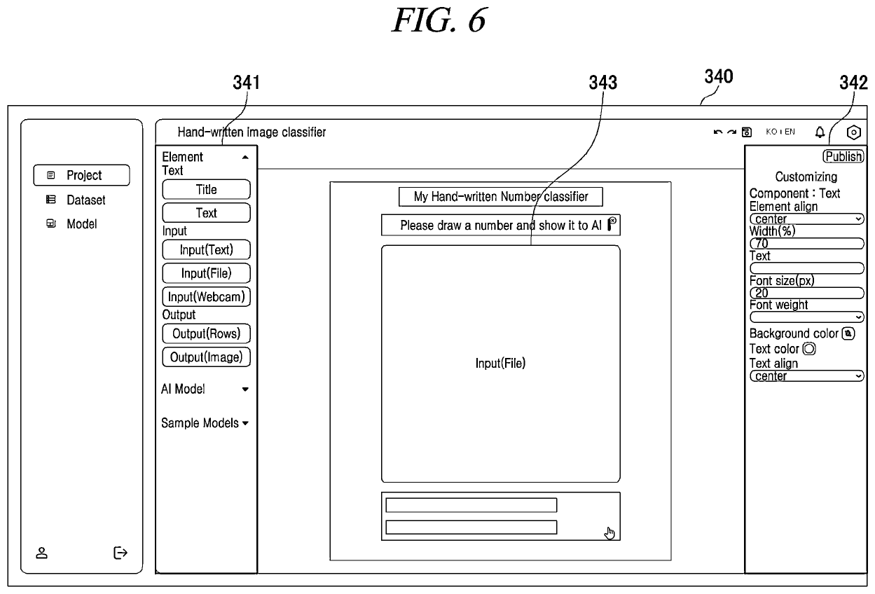

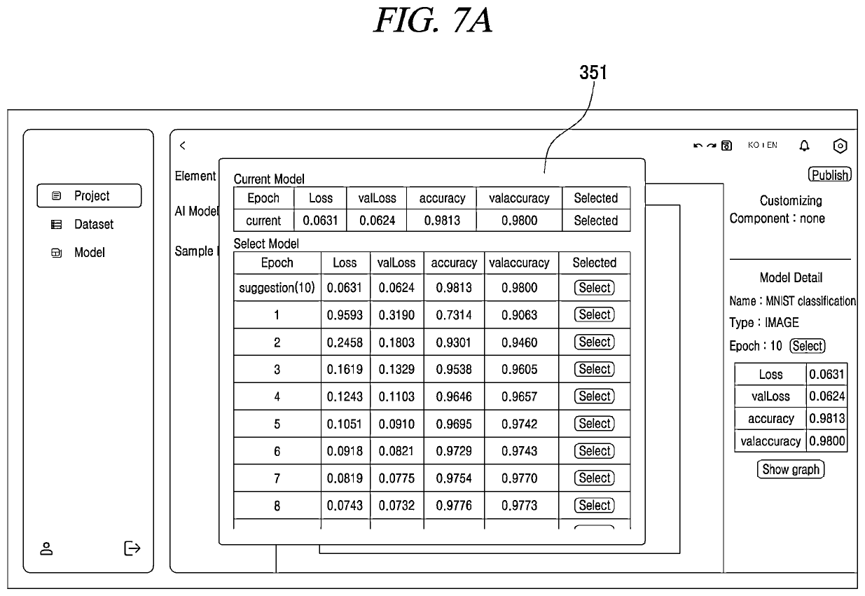

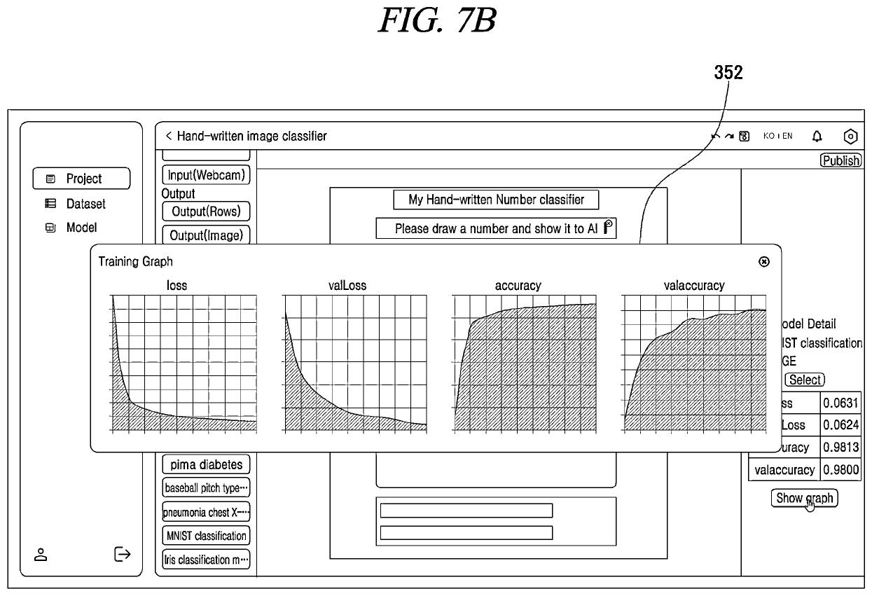

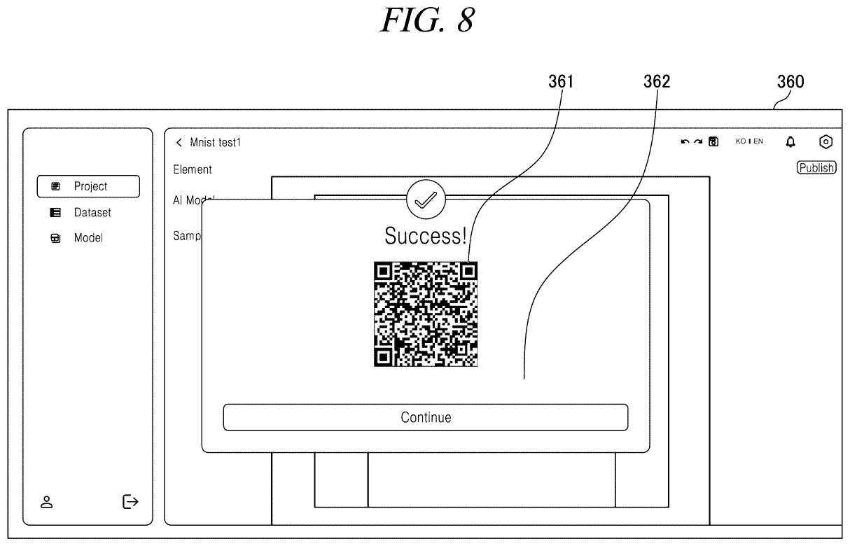

In more detail, FIGS. 3 and 4 are views illustrating examples of a terminal displaying respectively a login interface and an initial screen interface. FIG. 5 is a view illustrating an example of a terminal displaying the first template. FIG. 6 is a view illustrating an example of a terminal displaying the second template. FIGS. 7A and 7B are a view illustrating an example of a terminal displaying the third template. FIG. 8 is a view illustrating an example of a terminal displaying the fourth template.

Referring to FIGS. 3 to 8, a system may transmit a login interface 310, an initial screen interface 320, and the first interface to the terminal.

The login interface 310 may include a login information input portion 311 that inputs an ID and a password or logs in through an interlocked Google account. A terminal may transmit login information through the login interface 310. For example, the terminal may input an ID and a password or log in through the interlocked Google account.

The login interface 310 may include a member registration portion 312. The member registration portion 312 may enable membership registration or membership registration through a Google account. The terminal may transmit membership registration information to a system through the membership registration portion 312.

The initial screen interface 320 may include an app generation portion 321 and an app providing portion 322.

The app generation portion 321 may create a new app. When an execution signal of the app generation portion 321 is received from the terminal, the system may operate the app generation portion 321 to provide a first template 330.

The app providing portion 322 may provide names, descriptions, and links of previously created apps.

The first interface may include first to fourth templates 330, 340, 350, and 360 required to create an app.

The first template 330 may input basic information of an app and apply an AI model to the app. The first template 330 may include a name input portion 331, a description input portion 332, and an AI model information input portion 333.

The system may receive name information of an app from a terminal through the name input portion 331 of the first template 330.

The system may receive description information of the app from the terminal through the description input portion 332 of the first template 330.

The system may receive AI model information from the terminal through the AI model information input portion 333 of the first template 330. Here, the AI model information may be information on whether the terminal includes a trained AI model.

If there is a previously trained AI model, the AI model information input portion 333 may apply the corresponding AI model to the app.

The second template 340 may set a configuration of the app according to a user's selection. The second template 340 may include an element input portion 341, an app configuration information input portion 342, and an AI model upload portion 343.

The element input portion 341 may set elements required to configure an app. For example, the elements of the element input portion 341 may include at least one of a name, a text input, a file input, a webcam input, a row output, an image output, an AI model, and a sample model.

The app configuration information input portion 342 may set size information, location information, text color information, background color information, and alignment information of each of the elements of the element input portion 341. The system may receive at least one of size information, location information, character color information, background color information, and alignment information of each element from the terminal through the app configuration information input portion 342.

The AI model upload portion 343 may upload a pre-stored AI model. The system may receive the AI model from the terminal through the AI model upload portion 343.

When the AI model is received and the app is combined with the AI model, the system may transmit the third template 350 to the terminal.

The third template 350 may include an AI model training level input portion 351 for setting detailed information of the AI model and a training result checking portion 352.

The AI model training degree input portion 351 may set a training degree of the AI model. The training degree input portion 351 may provide a list of a plurality of training degree values and may select at least one of the plurality of training degree values. The system may receive training degree information of the AI model from the terminal through the training degree input portion 351 of the AI model.

The training result checking portion 352 may check a training result of the AI model as a graph or a numerical value. The system may transmit the training result of the AI model to the terminal through the training result checking portion 352.

The fourth template 360 may include an app link providing portion 361 required to provide the created app. The app link providing portion 361 may include at least one of a URL and a QR code through which the created app may be accessed or downloaded.

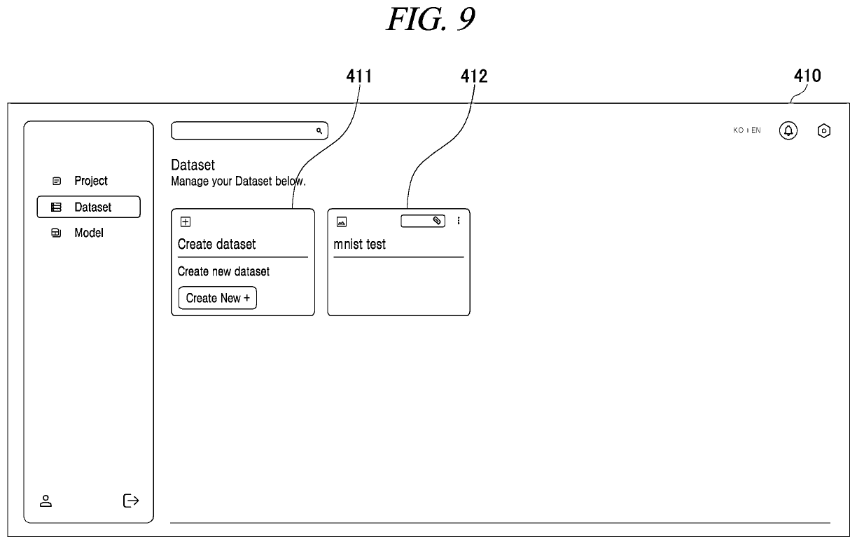

FIGS. 9 to 15B are views illustrating examples of the second interface displayed on a terminal through an application creation interface providing system according to an embodiment of the present disclosure.

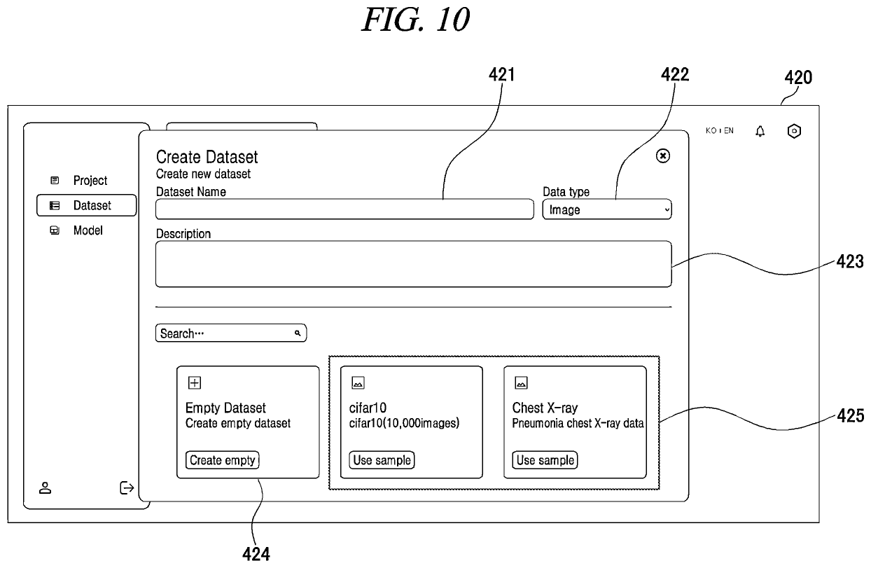

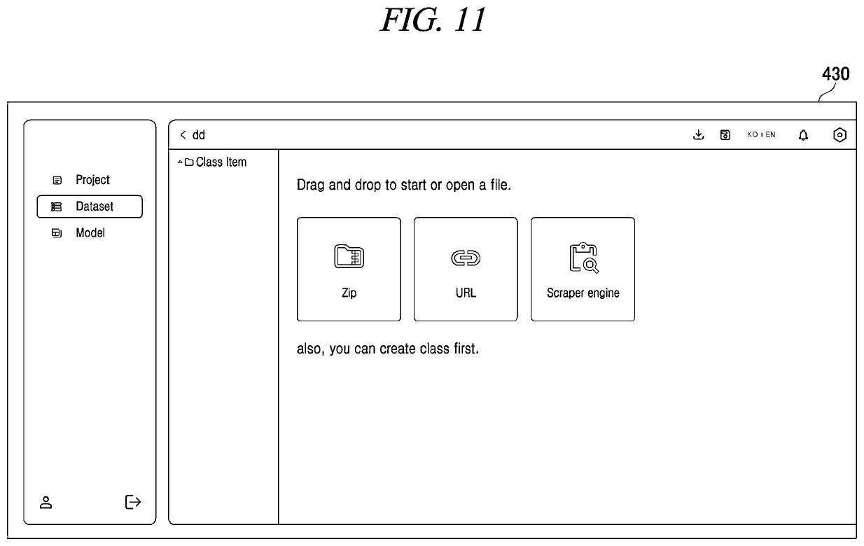

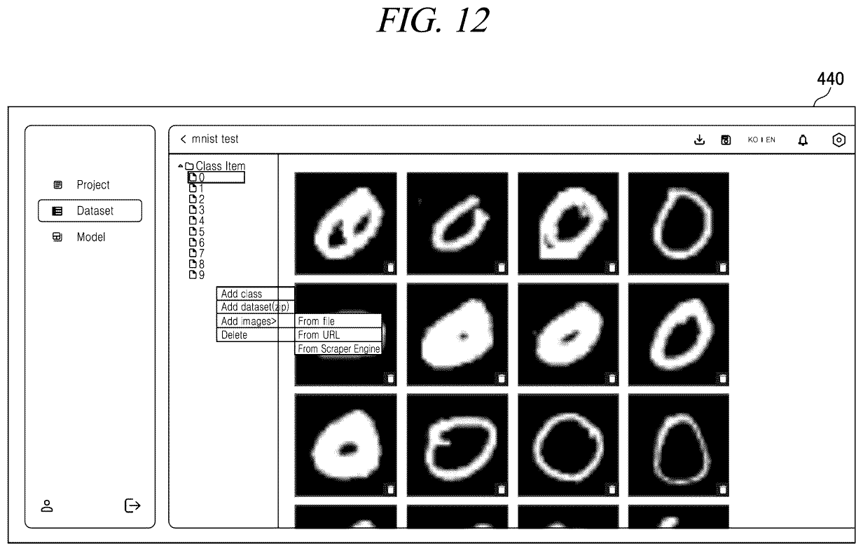

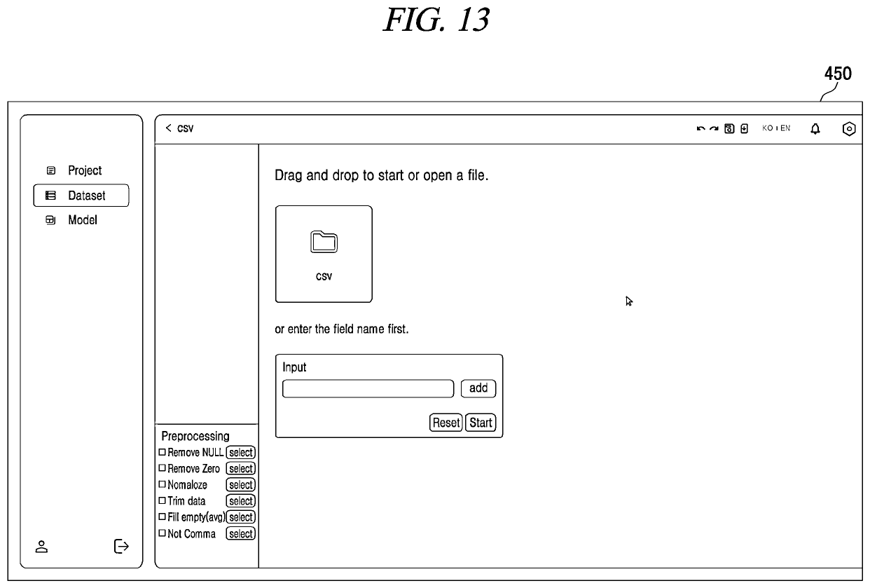

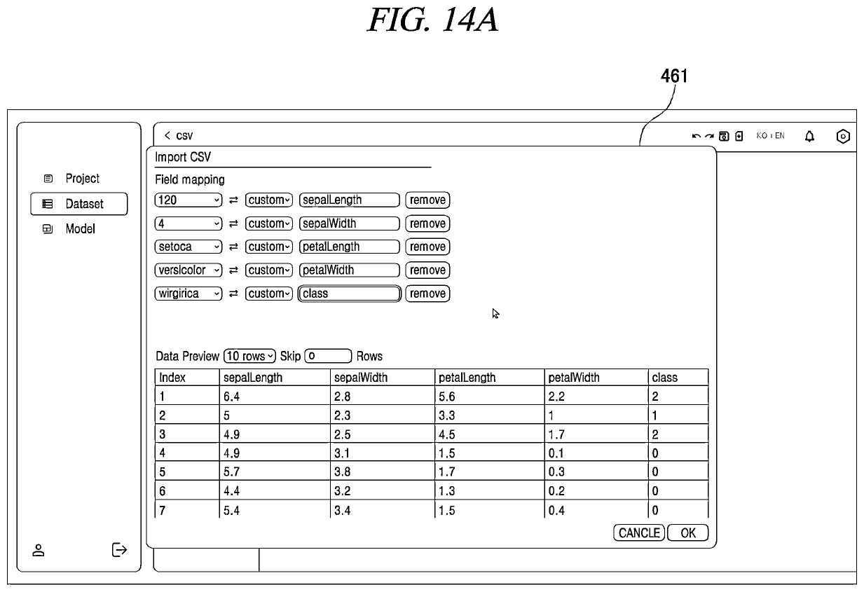

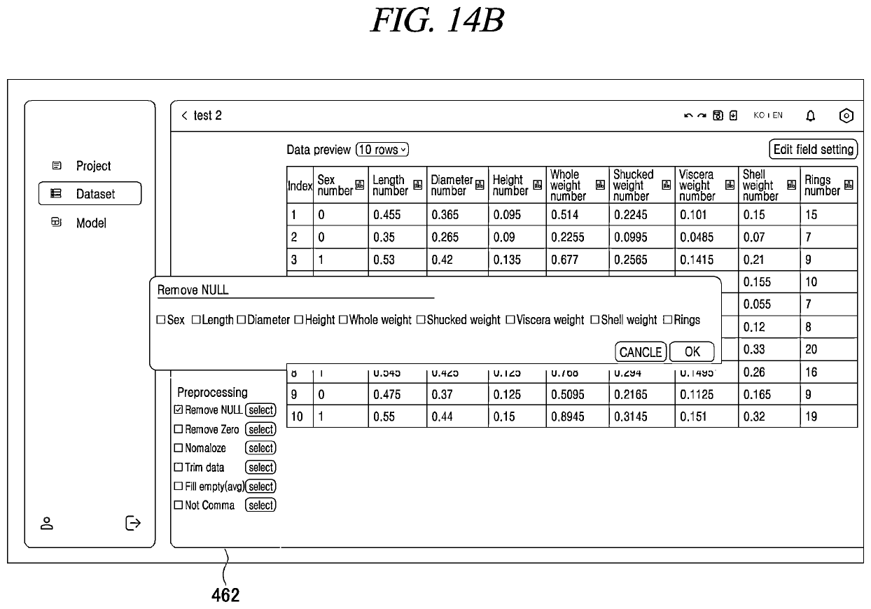

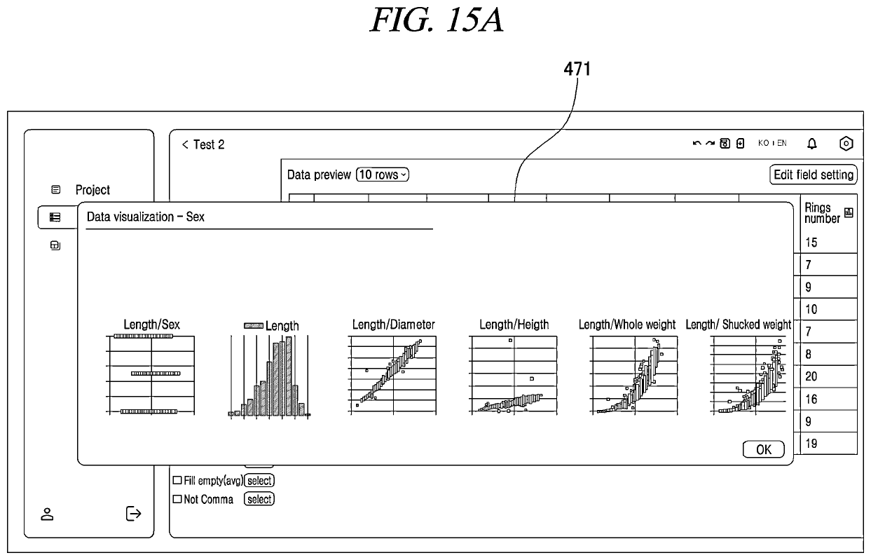

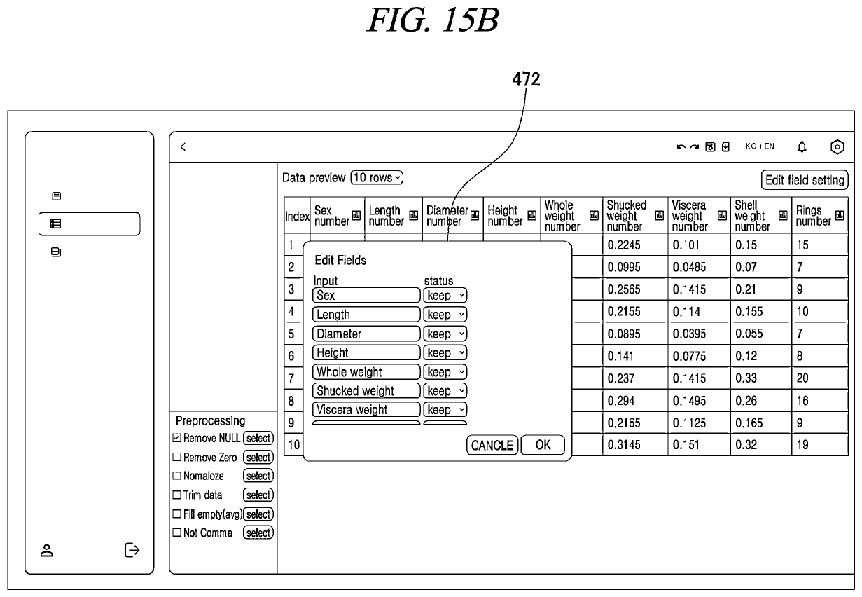

In more detail, FIG. 9 is a view illustrating an example of a terminal on which an AI model creation initial interface is displayed. FIG. 10 is a view illustrating an example of a terminal displaying a fifth template. FIG. 11 is a view illustrating an example of a terminal displaying a sixth template. FIG. 12 is a view illustrating an example of a terminal displaying a seventh template. FIG. 13 is a view illustrating an example of a terminal displaying an eighth template. FIGS. 14A and 14B are a view illustrating an example of a terminal displaying a ninth template. FIGS. 15A and 15B are a view illustrating an example of a terminal displaying a tenth template.

Referring to FIGS. 9 to 15, a system may transmit an AI model generation initial interface 410 and a second interface to a terminal.

The AI model generation initial interface 410 may allow generate of a new AI model. It may include an AI model generation portion 411 and an AI model providing portion 412. When an execution signal of the AI model generation portion 411 is received from the terminal, the system may operate the AI model generation portion 411 to provide a fifth template 420.

The AI model providing portion 412 may provide names, descriptions, and links of previously generated AI models.

The fifth template 420 may include a data name input portion 421, a data type input portion 422, a data description input portion 423, a learning data upload portion 424, and a learning data sample selection portion 425.

The data name input portion 421 may allow input of a name of a training dataset to be generated. The system may receive name information of the training dataset from the terminal through the data name input portion 421.

The data type input portion 422 may select which type of data to be trained is an image type or a CSV type. The system may receive data type information from the terminal through the data type input portion 422.

The data description input portion 423 may allow input of a description of a training dataset to be generated. The system may receive a description of the training dataset through data description input portion 423.

The learning data upload portion 424 may allow the terminal to upload learning data. When receiving a learning data upload signal from the terminal through the learning data upload portion 424, the system may provide one of the sixth template and the eighth template according to the data type.

The learning data sample selection portion 425 may provide learning data samples for training the AI model when learning data is not uploaded.

The sixth template 430 may allow learning data to be uploaded when the data type is an image. The sixth template 430 may allow learning data to be uploaded through at least one of a zip folder file, download through a URL, and Internet search crawling through a scraper engine. The system may receive image learning data through the sixth template 430.

The seventh template 440 may pre-process image learning data. The system may transmit a result of labeling for classifying the image learning data into classes by folder to a user terminal through the seventh template 440. Here, labels, which are results of labeling, may serve as correct answers when training data.

The system may receive image pre-processing information through the seventh template. For example, the terminal may check data for each folder in advance through the seventh template 440 and remove inappropriate data when there are any. In addition, the terminal may add a new class or new learning data through certain actions, such as right-click and double-click in a folder with labels.

The eighth template 450 may upload learning data when a data type is a CSV.

The ninth template may include a CSV name information correction portion 461 and a CSV learning data pre-processing portion 462.

The CSV name information correction portion 461 may correct a field name of the uploaded CSV data. Here, the field name may be a names of rows. The system may receive CSV name information from the terminal through the CSV name information correction portion 461.

The CSV learning data pre-processing portion 462 may pre-process CSV learning data. For example, the CSV learning data pre-processing portion 462 may perform at least one of removal of a column, removal of a NULL value, removal of zero, trimming, filling a blank, and removal of thousand-unit comma of the CSV learning data.

The tenth template may include a graph providing portion 471 and a training dataset storage portion 472.

The graph providing portion 471 may visualize and provide relative distribution display information obtained by matching the reference data column with data of another column and a bar graph of the selected data. When a graph generation signal is received by pressing a chart display button displayed next to the title of each data column from the terminal through the graph providing portion 471, the system may visualize and provide current data.

The training dataset storage portion 472 may store the generated training dataset. The terminal generates a storage signal by pressing an upper right floppy disk icon, and the system may receive the storage signal from the terminal to store the training dataset.

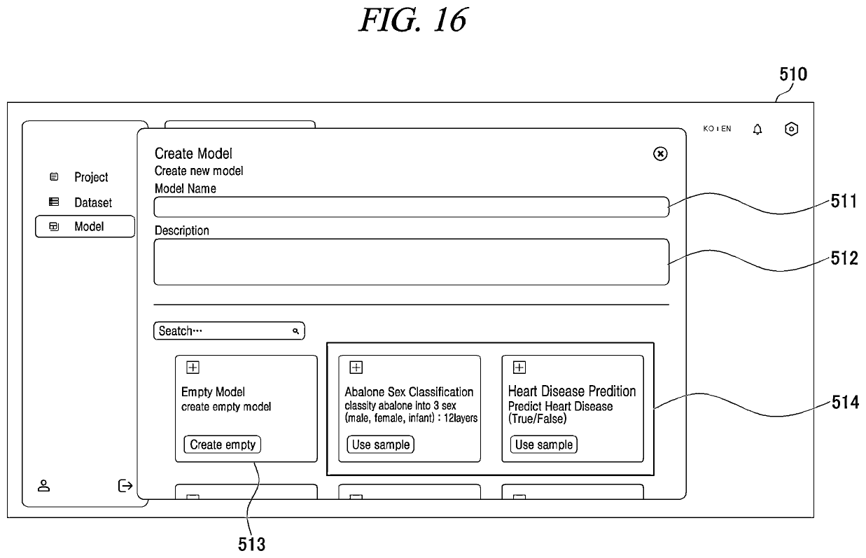

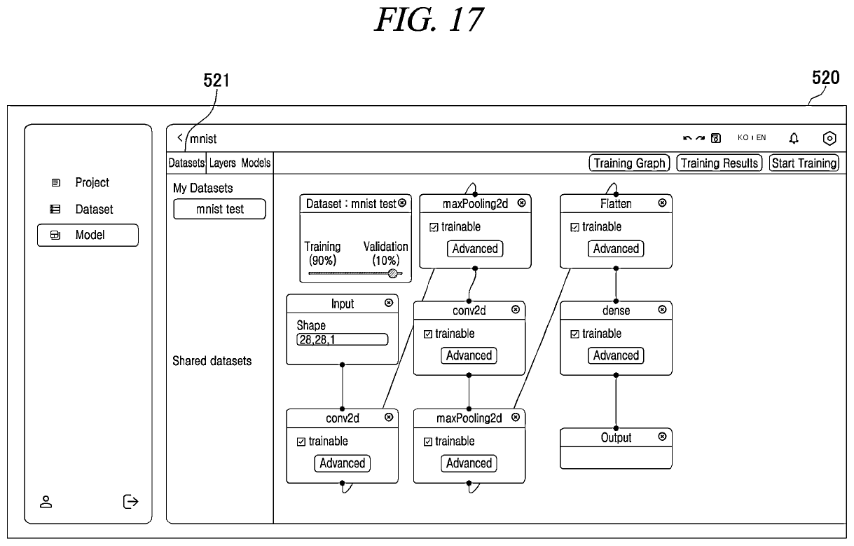

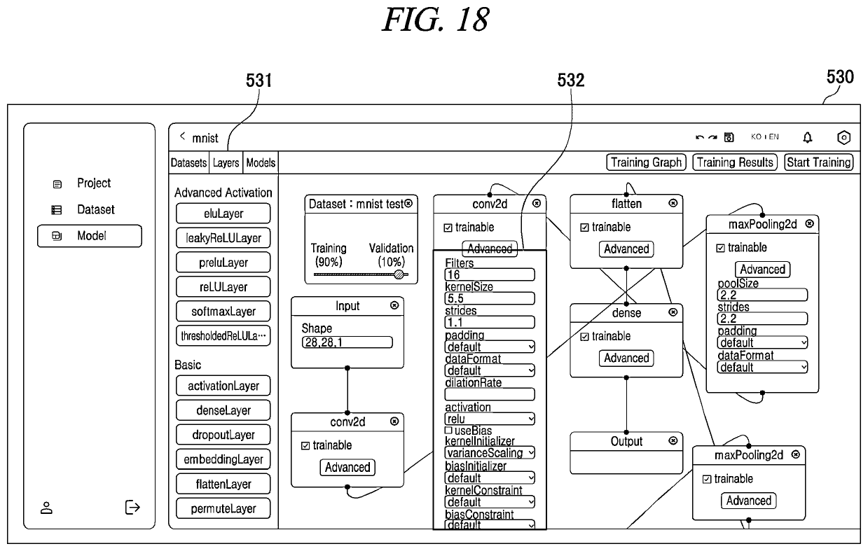

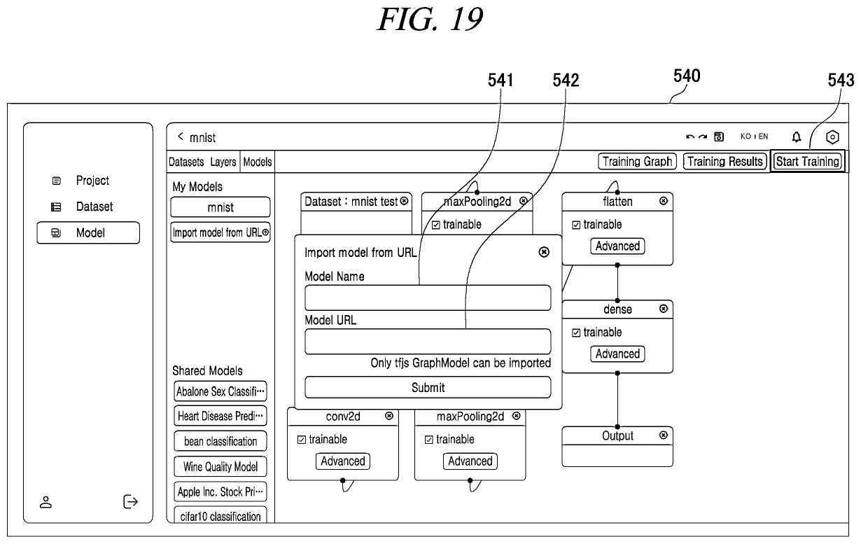

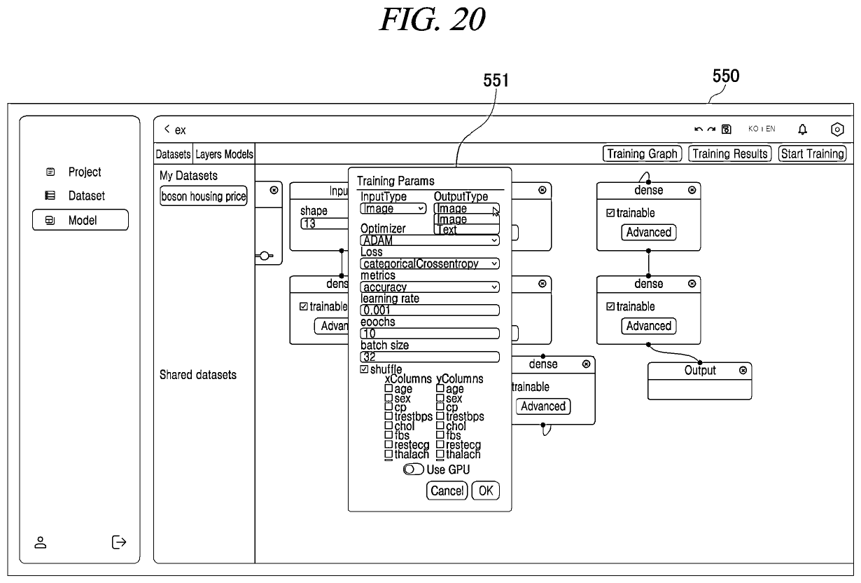

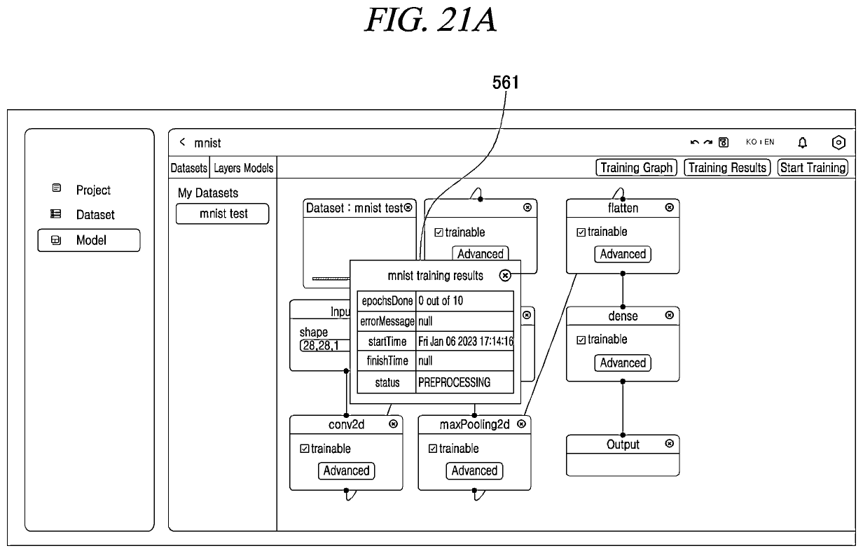

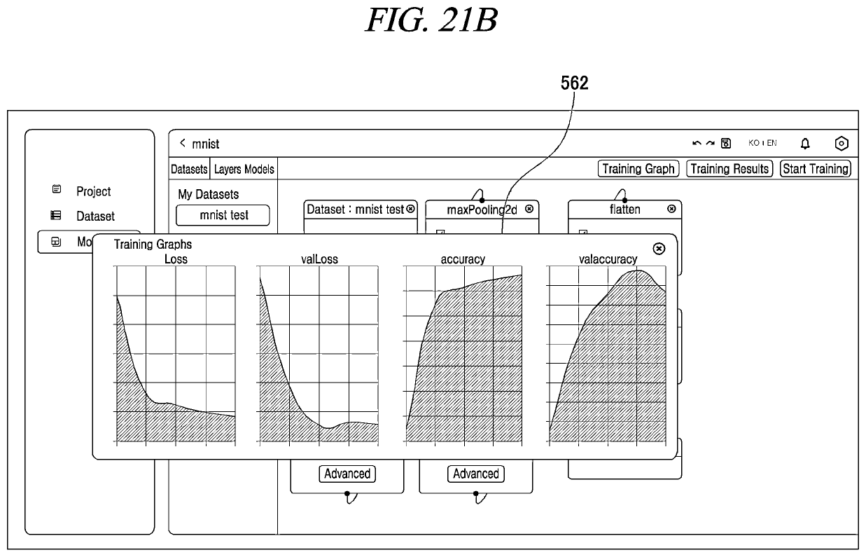

FIGS. 16 to 21B are views illustrating examples of a third interface displayed on a terminal through an application creation interface providing system according to an embodiment of the present disclosure. FIG. 16 is a view illustrating an example of a terminal displaying an eleventh template. FIG. 17 is a view illustrating an example of a terminal displaying a twelfth template. FIG. 18 is a view illustrating an example of a terminal displaying a thirteenth template. FIG. 19 is a view illustrating an example of a terminal displaying an external AI model use template. FIG. 20 is a view illustrating an example of a terminal displaying a fourteenth template. FIGS. 21A and 21B are a view illustrating an example of a terminal displaying a fifteenth template.

Referring to FIGS. 16 to 21, the system may transmit the third interface to the terminal. The third interface may include an external model use template 540 and the eleventh template 510 to the fifteenth template.

The eleventh template 510 may include an AI model name input portion 511, an AI model description input portion 512, a training data upload portion 513, and a training data sample selection portion 514.

The AI model name input portion 511 may allow input of a name of an AI model to be generated. The system may receive name information of the AI model from the terminal through the AI model name input portion 511.

The AI model description input portion 512 may allow a description of the AI model to be input. The system may receive description information of the AI model from the terminal through the AI model description input portion 512.

The training data upload portion 513 may upload a training dataset previously stored. The system may receive training dataset information from the terminal through the training data upload portion 513.

When there is no previously stored training dataset, the training data sample selection portion 514 may select at least one training dataset among samples of the training dataset. A training system may receive training dataset sample information from the terminal through the data sample selection portion 514.

The twelfth template 520 may include a training information selection portion 521 required to select a training dataset and a training and verification data ratio. The training information selection portion 521 may select the training and verification data ratio through scrolling. The system may receive the training and verification data ratio from the terminal through the training information selection portion 521.

The thirteenth template 530 may include a layer generation portion 531 and a layer setting portion 532.

The layer generation portion 531 may generate a layer constituting an AI model. The system may receive layer information from the terminal through the layer generation portion 531.

The layer setting portion 532 may set detailed elements of the layer. The system may receive layer setting information from the terminal through the layer setting portion 532. Here, the layer configuration information may include at least one of a filter, a kernel size, a width, a data format, an expansion rate, and activation.

The external model use template 540 may include an external model name input portion 541, an external model link input portion 542, and an external model training portion 543.

The external model name input portion 541 allows input of a name of an external model. The system may receive name information of the external model from the terminal through the external model name input portion 541.

The external model link input portion 542 may allow input a link of the external model. The system may receive link information of the external model from the terminal through the external model link input portion 542.

The external model training portion 543 may train the external model. The system may receive external model training information from the terminal through the external model training portion 543. The external model training information may indicate whether training of the external model starts.

The fourteenth template 550 may include a parameter setting portion 551.

The parameter setting portion 551 may set parameters required to train an AI model. The system may receive parameter information from the terminal through the parameter setting portion 551. Here, the parameter information may include input information, output information, data type information, optimizer information, loss value information, metric information, learning rate information, epoch information, batch size information, x value information, and y value information. When the training data is an image, the training data may further include image size information and channel information.

The fifteenth template may include an AI model training portion, a download portion, and monitoring portions 561 and 562.

Although not illustrated in the drawings, the AI model training portion may train an AI model based on the parameter information when receiving the parameter information.

Although not illustrated in the drawings, the download portion may store an AI model of which training is completed and enable the terminal to download the AI model.

The monitoring portions 561 and 562 may provide training conditions of the AI model in real time. For example, the monitoring portions 561 and 562 may provide a training result as a text or a training situation as a graph.

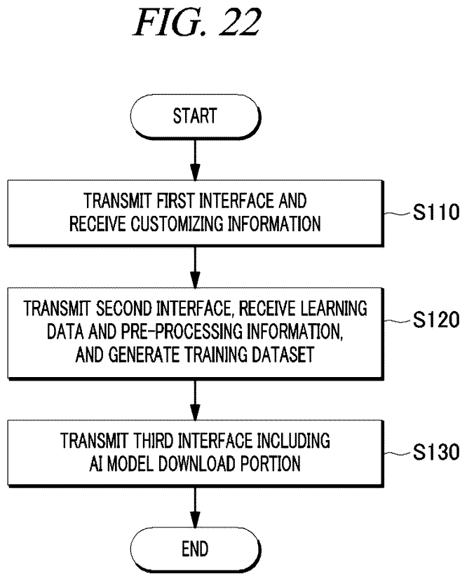

FIG. 22 is a flowchart illustrating processes of an application creation interface providing method according to another embodiment of the present disclosure.

An application creation interface providing method to be described below may be performed by the application creation interface providing system 100 of FIG. 1 described with reference to FIGS. 1 to 21B. Accordingly, contents of the embodiments of the present disclosure described above with reference to FIGS. 1 to 21B may be identically applied to the embodiments to be described below, and descriptions previously given with reference to FIGS. 1 to 21B are omitted. Steps described below do not have to be performed sequentially, a sequence of the steps may be set in various ways, and the steps may be performed almost simultaneously.

Referring to FIG. 22, the application creation interface providing method according to the present embodiment includes step S110 of transmitting a first interface and receiving customizing information, step S120 of transmitting a second interface, receiving learning data and pre-processing information, and generating a training dataset, and step S130 of transmitting a third interface including a download portion of an AI model. The application creation interface providing method is performed through a communication connection between a system and a terminal. Here, the system may be the application creation interface providing system 100 illustrated in FIG. 1, and the terminal may be the terminal 200 illustrated in FIG. 1.

Step S110 of transmitting the first interface and receiving the customization information is a step of transmitting, to the terminal, the first interface including a customizing information input portion applied to an AI-based app to be created and receiving customization information set by the terminal through the first interface from the terminal. For example, in step S110 of transmitting the first interface and receiving the customization information, the system may receive at least one of app name information, app description information, AI model information, app configuration information, and AI model training degree information from the terminal through the first interface.

Step S120 of transmitting the second interface, receiving the learning data and the pre-processing information, and generating the training dataset is a step being performed when AI model information applied to an app is missing from the customizing information.

Step S120 of transmitting the second interface, receiving the learning data and the pre-processing information, and generating the training dataset includes a step of uploading the training data and the pre-processing information required to generate the AI model applied to the app.

Step S120 of transmitting the second interface, receiving the learning data and the pre-processing information, and generating the training dataset includes a step of transmitting, to the terminal, the second interface including a function unit for pre-processing the learning data.

Step S120 of transmitting the second interface, receiving learning data and pre-processing information, and generating a training dataset (S120) includes receiving training data and pre-processing information necessary for generating an AI model applied to the app from the terminal through the second interface.

Step S120 of transmitting the second interface, receiving learning data and pre-processing information, and generating a training dataset (S120) includes a step of generating a training dataset by pre-processing the learning data according to the pre-processing information.

Step S130 of transmitting the third interface including a download portion of an AI model is a step of providing, to the terminal, the third interface including the download portion of the AI model applied to the app to output a certain result for a preset input based on the training dataset.

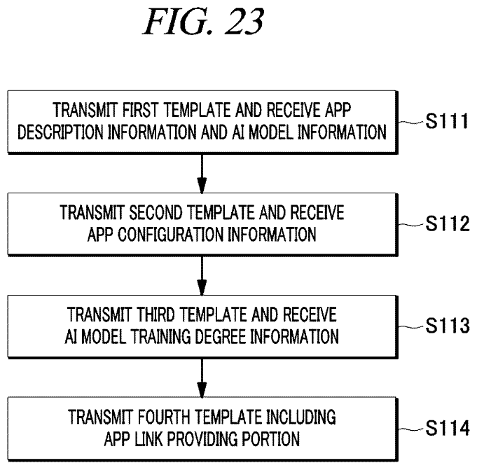

FIGS. 23 to 25 are flowcharts illustrating additional processes of the application creation interface providing method illustrated in FIG. 22.

Referring to FIG. 23, Step S110 of transmitting the first interface and receiving the customizing information may include step S111 of transmitting a first template and receiving app description information and AI model information, step S112 of transmitting a second template and receiving app configuration information, step S113 of transmitting a third template and receiving AI model training degree information, and step S114 of transmitting a fourth template including an app link providing portion.

Step S111 of transmitting the first template and receiving the description information and the AI model information may include a step of transmitting, to the terminal, the first template including an app name input portion, an app description input portion, and an AI model information input portion applied to the app.

Step S111 of transmitting the first template and receiving the description information and the AI model information may include a step of receiving the app name information, the app description information, and the AI model information through the first template.

Step S112 of transmitting the second template and receiving the app configuration information is a step of transmitting the second template including the app configuration information input portion required to create an app to the terminal and receiving the app configuration information through the second template.

Step S113 of transmitting the third template and receiving the training degree information of the AI model is a step of transmitting the third template including an AI model training degree input portion and an AI model training result checking portion to the terminal, and receiving AI model training degree information through the third template.

Step S114 of transmitting the fourth template including an app link providing portion includes a step of generating an app based on a basic app, a trained AI model, and app configuration information and providing the fourth template including an app link providing portion required to providing the created app.

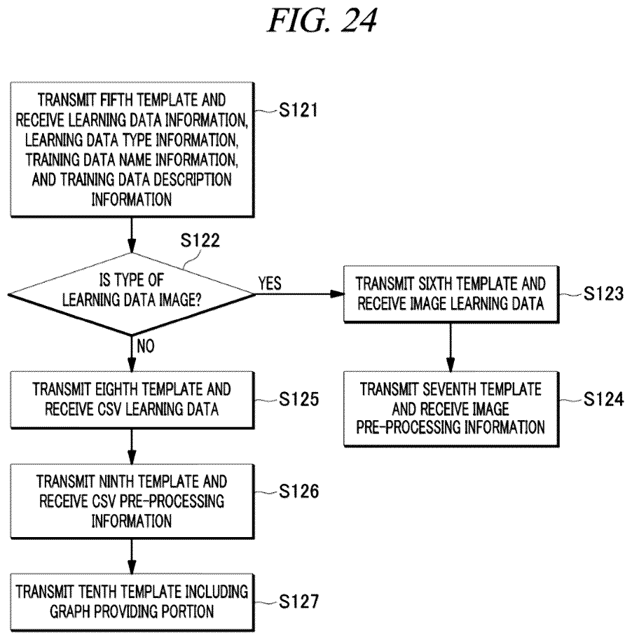

Referring to FIG. 24, step S120 of transmitting a second interface, receiving learning data and pre-processing information, and generating training dataset may include step S121 of transmitting a fifth template and receiving learning data information, learning data type information, training data name information, and training data description information, step S122 of determining the learning data type, step S123 of transmitting a sixth template and receiving image learning data, step S124 of transmitting a seventh template and receiving image pre-processing information, step S125 of transmitting an eighth template and receiving CSV learning data, step S126 of transmitting a ninth template and receiving CSV pre-processing information, and step S127 of transmitting a tenth template including a graph providing portion.

step S121 of transmitting the fifth template and receiving the learning data information, the learning data type information, the training data name information, and the training data description information may include a step of transmitting the fifth templet including a training data upload portion, a data name input portion, a data description input portion, and a data type input portion required to generate a training dataset.

step S121 of transmitting the fifth template and receiving the learning data information, the learning data type information, the training data name information, and the training data description information may include a step receiving the learning data information, the training data name information, the training data description information, and the learning type information through the fifth template.

Step S122 of determining the learning data type may be a step of determining whether the learning data type is an image or a CSV. When the learning data type is an image, step S123 may be performed, and when the learning data type is not an image, step S125 may be performed.

Step S123 of transmitting a sixth template and receiving image learning data is a step of transmitting the sixth template including an image learning data upload portion required to upload the image learning data to a terminal and receiving the image learning data through the sixth template.

Step S124 of transmitting the seventh template and receiving the image pre-processing information may include a step of transmitting the seventh template including an image pre-processing portion required to label, add or remove the image learning data to the terminal.

Step S124 of transmitting the seventh template and receiving the image pre-processing information may include a step of receiving the image pre-processing information through the seventh template.

Step S125 of transmitting the eighth template and receiving the CSV learning data may be a step of transmitting the eighth template including a CSV learning data upload portion required to upload the CSV learning data to the terminal 200 and receiving the CSV learning data through the eighth template.

Step S126 of transmitting the ninth template and receiving the CSV pre-processing information may include a step of transmitting the ninth template including a CSV information correction portion for CSV data information and a CSV learning data pre-processing portion required to pre-process the CSV learning data to the terminal.

Step S126 of transmitting the ninth template and receiving the CSV pre-processing information may include a step of receiving the CSV pre-processing information through the ninth template.

Step S127 of transmitting the tenth template including a graph providing portion may be a step of transmitting the tenth template including the graph providing portion required to visualize and display the CSV learning data generated through the pre-processing to the terminal.

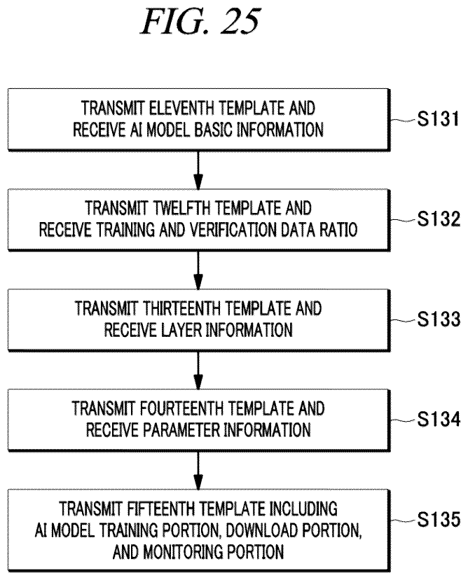

Referring to FIG. 25, step S130 of transmitting the third interface including the download portion of the AI model may include step S131 of transmitting an eleventh template and receiving AI model basic information, step S132 of transmitting a twelfth template and receiving a training and verification data ratio, step S133 of transmitting a thirteenth template and receiving layer information, step S134 of transmitting a fourteenth template and receiving parameter information, and step S135 of transmitting a fifteenth template including an AI model training portion, a download portion, and a monitoring portion.

Step S131 of transmitting the eleventh template and receiving the AI model basic information may include a step of transmitting the eleventh template including an AI model name input portion for inputting AI model basic information, an AI model description input portion, a training data upload portion, and a training data sample selection portion to a terminal.

Step S131 of transmitting the eleventh template and receiving the AI model basic information may include a step of receiving the AI model basic information through the eleventh template.

Step S132 of transmitting the twelfth template and receiving the training and verification data ratio may be a step of transmitting the twelfth template including a training information selection portion required to select the training and verification data ratio of the learning data to the terminal, and receiving the training and verification data ratio through the twelfth template.

Step S133 of transmitting the thirteenth template and receiving the layer information may be a step of transmitting the thirteenth template including a layer generation portion required to generate a layer constituting the AI model to the terminal and receiving layer information through the thirteenth template.

Step S134 of transmitting the fourteenth template and receiving the parameter information may be a step of transmitting the fourteenth template including a parameter setting portion required to set parameters required to train a model to the terminal and receiving parameter information through the fourteenth template.

Step S135 of transmitting the fifteenth template may include a step of training an AI model according to the set parameters.

Step S135 of transmitting the fifteenth template including an AI model training portion, a download portion, and a monitoring portion may include a step of storing the trained AI model and allowing the terminal to download the AI model.

Step S135 of transmitting the fifteenth template including an AI model training portion, a download portion, and a monitoring portion may include a step of providing a training situation of the stored AI model in real time.

Those skilled in the art to which the present disclosure belongs will be able to understand that the present disclosure may be easily modified into other specific forms without changing the technical idea or essential features of the present disclosure based on the above description. Therefore, the embodiments described above should be understood as illustrative in all respects and not limiting. The scope of the present disclosure is indicated by following claims, and all changes or modifications derived from the meaning and scope of the claims and equivalent concepts thereof should be construed as being included in the scope of the present disclosure. The scope of the present application is indicated by the following claims rather than the detailed description above, and all changes or modifications derived from the meaning and scope of the claims and equivalent concepts thereof should be construed as being included in the scope of the present application.

According to the present disclosure, an application may be easily built with just a few clicks, without requiring manual work of a developer when creating the application from a pretrained deep learning model, and thus, development productivity of an application may be maximized.

In addition, according to the present disclosure, convenience of creating an application may be increased by generating the application according to a user's selection input to the provided interface.

In addition, according to the present disclosure, non-experts may create applications without information on coding.

Effects of the present disclosure are not limited to the effects described above, and include all effects understood from the following description.

The present disclosure is an AI-based application creation interface control technology and may be used for app creation technology that provides an interface related to app creation such that users may easily create AI-based apps without a separate coding process, and accordingly, the present disclosure has industrial applicability.

What is claimed is:

1. An artificial intelligence-based application creation interface providing method performed through a communication connection between a system and a terminal, the artificial intelligence-based application creation interface providing method comprising:
a) transmitting, by the system, a first interface including a customizing information input portion applied to an artificial intelligence-based application to be created to the terminal and receiving customizing information set by the terminal from the terminal through the first interface;
b) uploading learning data and pre-processing information required to generate an artificial intelligent model applied to the application when artificial intelligence model information applied to the application is missing from the customizing information, transmitting a second interface including a function unit for pre-processing the learning data to the terminal, receiving the learning data and the pre-processing information required to generate the artificial intelligence model applied to the application from the terminal through the second interface, and generating a training dataset by pre-processing the learning data according to the pre-processing information by using the system; and
c) providing, by the system, a third interface including a download portion of the artificial intelligence model applied to the application to the terminal to output a certain result for a preset input based on the training dataset.

2. The artificial intelligence-based application creation interface providing method of claim 1, wherein
the first interface includes a first template to a fourth template required to create the application.

3. The artificial intelligence-based application creation interface providing method of claim 1, wherein
the second interface includes a fifth template to a tenth template required to generate a training dataset by pre-processing the learning data.

4. The artificial intelligence-based application creation interface providing method of claim 1, wherein
the third interface generates the artificial intelligence model applied to the app, trains the artificial intelligence model, and includes an eleventh template to a fifteenth template required to download the artificial intelligence model applied to the application.

5. The artificial intelligence-based application creation interface providing method of claim 2, wherein a) includes:
a-1) transmitting the first template including an application name input portion, an application description input portion, and an artificial intelligence model information input portion applied to the application to the terminal, and receiving application name information, application description information, and artificial intelligence model information through the first template by using the system;
a-2) transmitting the second template including an application configuration information input portion required to create the application to the terminal, and receiving application configuration information through the second template by using the system;
a-3) transmitting the third template including an artificial intelligence model training degree input portion and an artificial intelligence model training result checking portion to the terminal, and receiving artificial intelligence model training degree information through the third template by using the system; and
a-4) providing, by the system, the fourth template including an application link providing portion required to provide the created application based on a-1) to a-3).

6. The artificial intelligence-based application creation interface providing method of claim 3, wherein b) includes:
b-1) transmitting the fifth template including a learning data upload portion, a data name input portion, a data description input portion, and a data type input portion required to generate the training dataset to the terminal, and receiving learning data information, training data name information, training data description information, and learning data type information through by using the system; and
b-2) providing, by the system, a different template according to a type of the training dataset received from the terminal.

7. The artificial intelligence-based application creation interface providing method of claim 6, wherein b-2) includes:
transmitting the sixth template including an image learning data upload portion required to upload the image learning data to the terminal when a type of the learning data is an image dataset, and receiving the image learning data through the sixth template by using the system; and
transmitting the seventh template including an image pre-processing portion required to label, add, or remove the image learning data to the terminal, and receiving image pre-processing information through the seventh template by using the system.

8. The artificial intelligence-based application creation interface providing method of claim 6, wherein b-2) includes:
transmitting the eighth template including a comma separated value (CSV) learning data upload portion required to upload CSV learning data to the terminal when a type of the learning data is CSV data of a CSV format, and receiving the CSV learning data through the eighth template by using the system;
transmitting the ninth template including a CSV information correction portion for information of the CSV learning data and a CSV learning data pre-processing portion required to pre-process the CSV learning data to the terminal, and receiving CSV pre-processing information through the ninth template by using the system; and
transmitting the tenth template including a graph providing portion required to visualize and display the CSV learning data generated through pre-processing to the terminal by using the system.

9. The artificial intelligence-based application creation interface providing method of claim 4, wherein c) includes:
c-1) transmitting the eleventh template including an artificial intelligence model name input portion for inputting basic information of the artificial intelligence model, an artificial intelligence model description input portion, a training data upload portion, and a training data sample selection portion to the terminal, and receiving name information, description information, and training data information of the artificial intelligence model through the eleventh template by using the system;
c-2) transmitting the twelfth template including a training information selection portion required to select a training and verification data ratio of the training data to the terminal, and receiving the training and verification data ratio through the twelfth template by using the system;
c-3) transmitting the thirteenth template including a layer generation portion to generate a layer constituting the artificial intelligence model to the terminal, and receiving layer information through the thirteenth template by using the system;
c-4) transmitting the fourteenth template including a parameter setting portion required to set a parameter necessary for training the artificial intelligence model to the terminal, and receiving parameter information through the fourteenth template by using the system; and
c-5) transmitting, to the terminal, the fifteenth template including an artificial intelligence model training portion required to train the artificial intelligence model according to the parameter information, a download portion required to store the trained artificial intelligence model and required for the terminal to download the artificial intelligence model, and a real-time monitoring portion required to provide a training situation of the stored artificial intelligence model in real time by using the system.

10. An artificial intelligence-based application creation interface providing system comprising:
a communication module;
at least one processor; and
a memory electrically connected to the processor and configured to store at least one code executed by the processor;
wherein, when the memory is operated by the processor, the processor
transmits a first interface including a customizing information input portion applied to an artificial intelligence-based application to be created to a terminal communicatively connected to the communication module, receives customizing information set by the terminal from the terminal through the first interface,
uploads learning data and pre-processing information required to generate an artificial intelligent model applied to the application when artificial intelligence model information applied to the application is missing from the customizing information, transmits a second interface including a function unit for pre-processing the learning data to the terminal, receives the learning data and the pre-processing information required to generate the artificial intelligence model applied to the application from the terminal through the second interface, and generates a training dataset by pre-processing the learning data according to the pre-processing information, and
provides a third interface including a download portion of the artificial intelligence model applied to the application to the terminal to output a certain result for a preset input based on the training dataset.

11. The artificial intelligence-based application creation interface providing system of claim 10, wherein
the first interface includes a first template to a fourth template required to create the application.

12. The artificial intelligence-based application creation interface providing system of claim 10, wherein
the second interface includes a fifth template to a tenth template required to generate a training dataset by pre-processing the learning data.

13. The artificial intelligence-based application creation interface providing system of claim 10, wherein
the third interface generates the artificial intelligence model applied to the app, trains the artificial intelligence model, and includes an eleventh template to a fifteenth template required to download the artificial intelligence model applied to the application.

14. The artificial intelligence-based application creation interface providing system of claim 11, wherein the memory causes the processor to
transmit the first template including an application name input portion, an application description input portion, and an artificial intelligence model information input portion applied to the application to the terminal, receive application name information, application description information, and artificial intelligence model information through the first template,
transmit the second template including an application configuration information input portion required to create the application to the terminal, receive application configuration information through the second template,
transmit the third template including an artificial intelligence model training degree input portion and an artificial intelligence model training result checking portion to the terminal, receive artificial intelligence model training degree information through the third template, and
store a code causing the fourth template including an application link providing portion required to provide the created application to be provided.

15. The artificial intelligence-based application creation interface providing system of claim 12, wherein the memory causes the processor to
transmit the fifth template including a learning data upload portion, a data name input portion, a data description input portion, and a data type input portion required to generate the training dataset to the terminal, and receive learning data information, training data name information, training data description information, and learning data type information through, and
store a code causing a different template according to a type of the training dataset received from the terminal to be provided.

16. The artificial intelligence-based application creation interface providing system of claim 15, wherein the memory causes the processor to
transmit the sixth template including an image learning data upload portion required to upload the image learning data to the terminal when a type of the learning data is an image dataset, and receive the image learning data through the sixth template,
transmit the seventh template including an image pre-processing portion required to label, add, or remove the image learning data to the terminal, and store a code causing image pre-processing information to be received through the seventh template.

17. The artificial intelligence-based application creation interface providing system of claim 15, wherein the memory causes the processor to
transmit the eighth template including a comma separated value (CSV) learning data upload portion required to upload CSV learning data to the terminal when a type of the learning data is CSV data of a CSV format, receive the CSV learning data through the eighth template,
transmit the ninth template including a CSV information correction portion for information of the CSV learning data and a CSV learning data pre-processing portion required to pre-process the CSV learning data to the terminal, receive CSV pre-processing information through the ninth template, and
store a code causing the tenth template including a graph providing portion required to visualize and display the CSV learning data generated through pre-processing to be transmitted to the terminal.

18. The artificial intelligence-based application creation interface providing system of claim 13, wherein the memory causes the processor to
transmit the eleventh template including an artificial intelligence model name input portion for inputting basic information of the artificial intelligence model, an artificial intelligence model description input portion, a training data upload portion, and a training data sample selection portion to the terminal, and receive name information, description information, and training data information of the artificial intelligence model through the eleventh template,
transmit the twelfth template including a training information selection portion required to select a training and verification data ratio of the training data to the terminal, receive the training and verification data ratio through the twelfth template,
transmit the thirteenth template including a layer generation portion to generate a layer constituting the artificial intelligence model to the terminal, receive layer information through the thirteenth template,
transmit the fourteenth template including a parameter setting portion required to set a parameter necessary for training the artificial intelligence model to the terminal, receive parameter information through the fourteenth template, and
store a code causing the fifteenth template including an artificial intelligence model training portion required to train the artificial intelligence model according to the parameter information, a download portion required to store the trained artificial intelligence model and required for the terminal to download the artificial intelligence model, and a real-time monitoring portion required to provide a training situation of the stored artificial intelligence model in real time to be transmitted to the terminal.
